(19) United States
(12) Patent Application Publication
(10) Pub. No.: US 2021/0278126 A1
(43) Pub. Date: Sep. 9, 2021

(54) METHODS, SYSTEMS AND APPARATUS FOR REMOTE DIAGNOSTICS AND CONTROL OF ROBOT

(71) Applicant: InTunes Products, LLC, Webster, NY (US)

(72) Inventor: Mostafa Ghobadi, Webster, NY (US)

(73) Assignee: InTunes Products, LLC, Webster, NY (US)

(21) Appl. No.: 17/195,079

(22) Filed: Mar. 8, 2021

Related U.S. Application Data
(60) Provisional application No. 63/086,933, filed on Oct. 2, 2020.
(60) Provisional application No. 62/986,193, filed on Mar. 6, 2020.

(51) Int. Cl. F25D 25/00; B25J 9/16; B25J 13/00

(52) U.S. Cl. CPC F25D 25/00; B25J 9/1674; F25D 2331/803; B25J 9/1697; B25J 9/1679; B25J 13/006

(57) ABSTRACT

A cabinet for consumer goods includes a cabinet housing and a rack system disposed within the cabinet housing. The rack system defines a plurality of discrete locations, with each respective location configured to hold and display a respective consumer good therein. A multi-axis robotic arm may selectively engage each respective location of the plurality of discrete locations to either insert or extract a respective consumer good. A user control interface is in operational communication with the multi-axis robotic arm so that a user can control the multi-axis robotic arm to selectively insert or extract one or more of the consumer goods from its respective location. An access door is located within the cabinet housing and is movable between an open position and a closed position. The selectively extracted consumer good is retrievable from the cabinet housing when the access door is in the open position.

### BACKGROUND OF THE INVENTION

The present invention generally relates to robots. More particularly, the invention relates to methods, systems and apparatus for remote diagnosing and repair of a robotic apparatus. The invention further relates to multi-axis arm robots equipped with a tool configured to manipulate and display consumer retail goods.

Robots, and particularly robots with tool-equipped multi-axis arms, are commonplace in industrial settings. Less common are tool-equipped multi-axis robots in retail settings and living spaces, for example. One possible reason for this is that robots, like most electromechanical devices, are subject to occasional operational failure requiring on-site inspection and repair. Robotic apparatus are more specialized and complicated than many other types of common mechanical devices and they thus require a technician or engineer that specializes in robotics. While robotic engineers are usually readily available in an industrial setting, they may not be readily available in other settings, leading to much longer periods of robot downtime. There is thus a need for shortening the diagnostic and repair times of robotic apparatus in settings where robotic engineers are not immediately available for on-site robotic diagnostic and repair work.

### SUMMARY OF THE INVENTION

The present invention addresses the above stated need by providing methods, systems and apparatus for remotely diagnosing the failure mode of a robot such as a tool-equipped multi-axis arm robot, for example.

In one possible embodiment of the invention, a robot with a multi-axis arm having a gripping tool is provided within a cabinet for holding a collection of consumer retail goods, such as wine bottles, for storage, viewing and retrieval. Such cabinets may be designed in various sizes and stylish configurations adapted to a particular setting, such as private homes and restaurants, for example. Particular embodiments of the invention may be of elite design and architecture for the most avid collectors and connoisseurs of fine wine. Although bottles of wine are described herein, it is understood that the invention may have applicability to other types of goods (e.g., liquor bottles, electronic goods, etc.) and is therefore not to be construed as limited to wine bottles.

User controls may be provided on the cabinet, such as through a keypad or touchscreen, thereby allowing a user to perform a variety of functions via control software. Such user tasks may include instructing the robot to load a plurality of wine bottles into a particular stacked array within the cabinet which may be viewed through transparent cabinet panels, for example. Another task may be instructing the robot to retrieve a specific wine bottle for close viewing through a transparent panel where the user control panel may present a list of wine bottles in the cabinet available for user selection. Yet another task may be instructing the robot to deliver the selected wine bottle to the use via a cabinet access door. Yet another task may be instructing the robot to place the selected wine bottle into a chiller inside the cabinet prior to delivering the wine bottle to the user. This is only a partial list of several examples of the many different types of potential user tasks, some of which will be discussed more fully below.

In the event of a robot malfunction, the system software is adapted to connect, such as through an Ethernet or WIFI connection, to a remote robotic engineer who may perform diagnostic testing on the robot to diagnose the reason for the malfunction. Should the malfunction be remotely repairable, for example via a software download executed by the robotic engineer, the repair is made in what is hopefully a minimum amount of time, perhaps on the order of a few minutes. It is noted that the ability to remotely diagnose and repair any robotic malfunction is immensely attractive and valuable from a marketing standpoint in that a potential client would not be as inclined to purchase such a product if it were subject to long periods of downtime.

Additional objects, advantages and novel features of the present invention will be set forth in part in the description which follows, and will in part become apparent to those in the practice of the invention, when considered with the attached figures.

### BRIEF DESCRIPTION OF THE DRAWING FIGURES

The accompanying drawing figures forms a part of this specification and are to be read in conjunction therewith, wherein like reference numerals are employed to indicate like parts in the various views, and wherein:

FIGS. 1A-1C are perspective views of various embodiments of the invention in different environmental settings;

FIG. 2 is a cross sectional elevational view of an embodiment of the invention;

FIG. 3 is a perspective view of an embodiment of the invention;

FIG. 4A is a front perspective view of an embodiment of a base that may be used within the invention;

FIG. 4B is a rear perspective view of the base shown in 4A;

FIG. 5 is a front perspective view of a component of an embodiment of the invention;

FIG. 6 front bottom perspective view of a camera that may be used within an embodiment of the invention;

FIG. 7 is an side view of the camera shown in FIG. 6;

FIG. 8 is a representative screenshot using software that may be used within an embodiment of the invention;

FIG. 9 is a camera view of a first camera located at the top of the cabinet looking downward;

FIG. 10 is a camera view of a second camera mounted on the end of a multi-axis robotic arm used within an embodiment of the invention;

FIG. 11 is a camera view of a third camera used within an embodiment of the invention;

FIG. 12 is an exemplary screenshot of a robot control interface in accordance with an embodiment of the invention;

FIG. 13 is an exemplary screenshot of a remote maintenance “Alerts Manager” interface in accordance with an embodiment of the invention; and

FIG. 14 is an exemplary screenshot of a termination screen following remote maintenance of an embodiment of the invention.

### DETAILED DESCRIPTION OF PREFERRED EMBODIMENTS

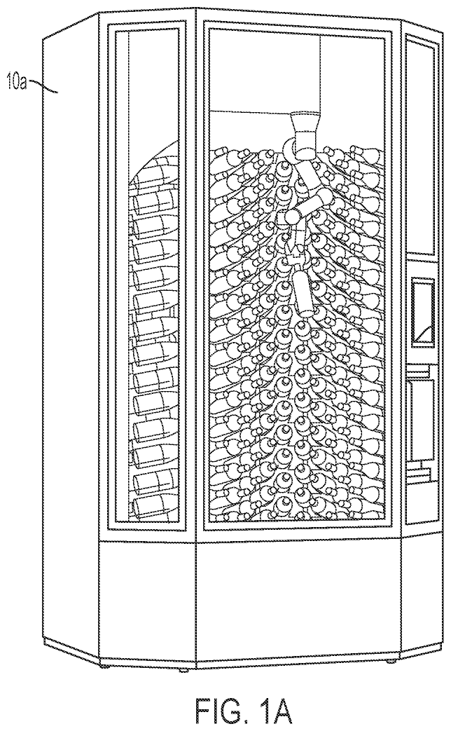

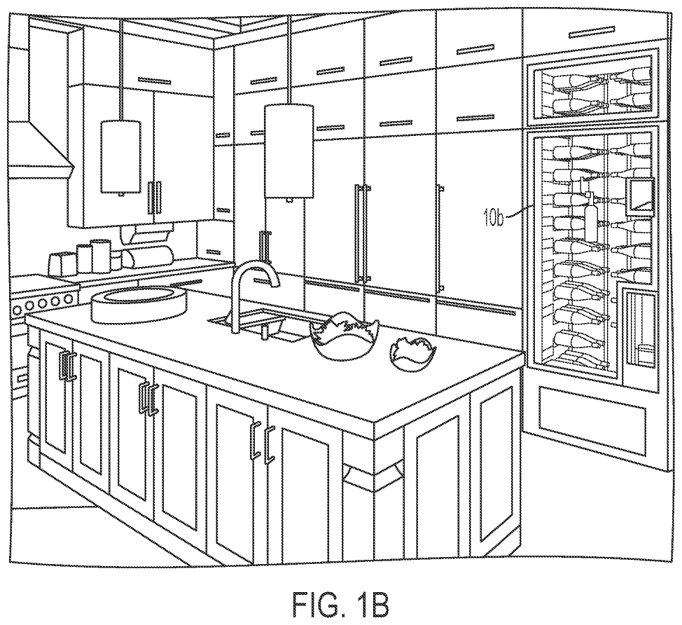

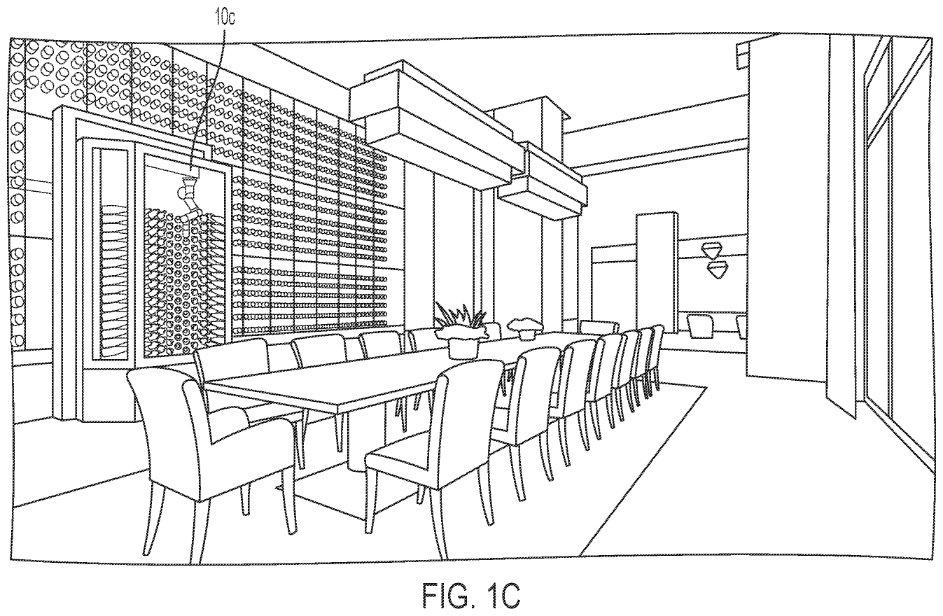

Referring to the Figures, there is seen in FIG. 1A an embodiment of the invention in the form of a free standing wine enclosure or wine cabinet indicated generally by the reference numeral 10a. FIGS. 1B and 1C illustrate other potential embodiments 10b and 10c, respectively, in settings such as a home kitchen (FIG. 1B) or a home living area or restaurant (FIG. 1C), for example, where the cabinet may be built-in rather than free standing. It will thus be appreciated that the invention may be provided in various configurations and sizes.

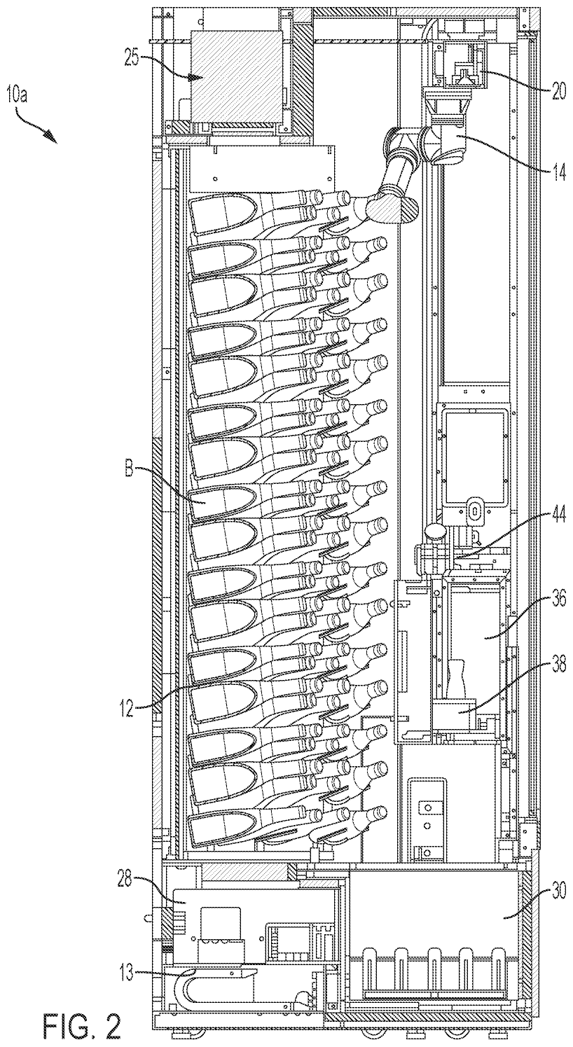

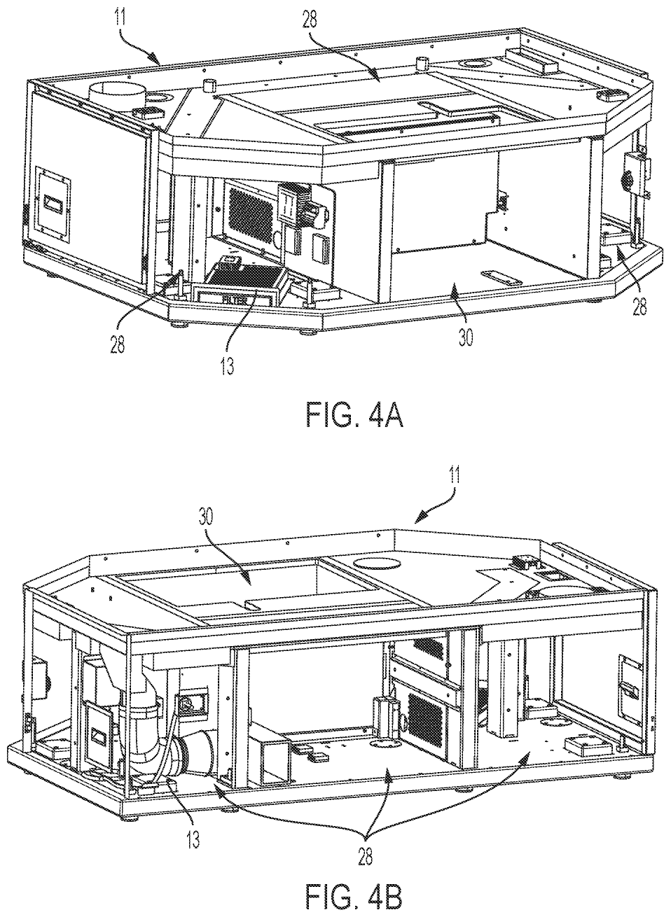

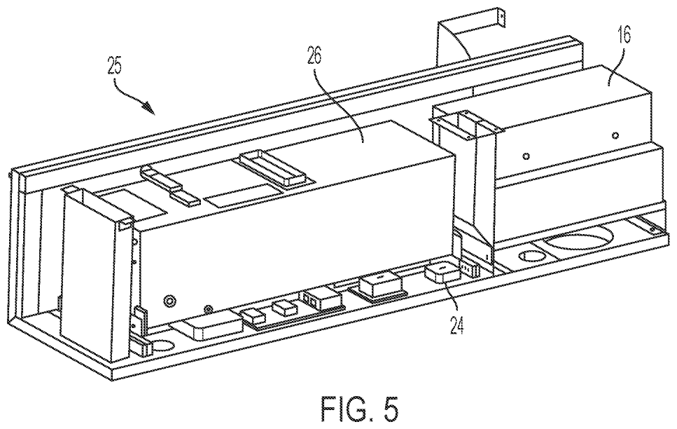

With reference to FIGS. 2 and 4, and using wine cabinet 10a as an exemplary embodiment for purposes of description, within the wine cabinet 10a are one or more bottle racks 12 for holding bottles “B” (FIG. 2). A multi-axis robotic arm 14 operated via controller 16 (see also FIG. 5) is provided within the wine cabinet 10a and includes a bottle handling tool 18 at the terminal end of the arm 14. Tool 18 may be of various configurations adapted for picking, maneuvering, and placing bottles B within the cabinet. Robotic arm 14 may be mounted to an inner wall surface of the cabinet 10a or provided on a gantry 20 which allows robotic arm 14 to travel vertically and/or horizontally and/or orthogonally within the cabinet 10a.

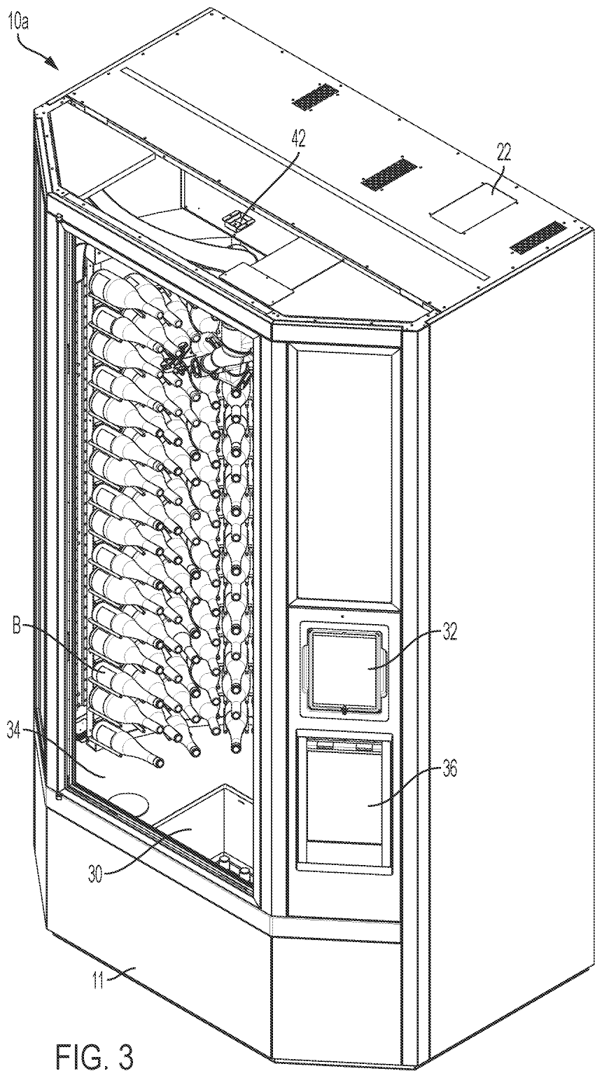

Wine cabinet 10a may further include components for establishing an internet connection such as a global WIFI adapter 22 (FIG. 3) and, with additional reference to FIG. 5, a local WIFI router 24. WIFI router 24 may be housed within a controller/chiller unit 25 which also includes controller 16 and a chiller 26 which may be provided to maintain a desired temperature within cabinet 10a. Chiller 26 may be of any desired type operable to select, set and maintain a desired enclosure temperature.

An enclosure 28 may be provided, such as proximate to or within cabinet base 11, within cabinet 10a to house electronic controls 13 operating the electrical components of the invention. (see also FIGS. 4A and 4B). A compartment 30 may also be provided within cabinet base 11 to facilitate loading of additional bottles B into the cabinet 10a when desired or required. The compartment 30 may be configured as a drawer, for example.

As seen in FIG. 3, a user control interface 32 may be provided on an exterior surface of cabinet 10a. Interface 32 may be provided in the form of a computer touch screen.

Some or all available robot and cabinet control functions may be accessible via interface 32 as described more fully below.

In the preferred embodiment, cabinet 10a includes one or more transparent panels 34 to allow the user to view the wine bottles B within the cabinet. The racks 12 in which the bottles B are removably held within the cabinet 10a are preferably arranged in an array which is visually pleasing while keeping the bottles at an angle best known for wine bottle storage.

Referring to FIGS. 4 and 4A, a bottle access door 36 may be provided on a wall of the cabinet 10a where through a user may retrieve a bottle B of wine placed by the robot in load cell 38. Bottle access door 36 may be located proximate interface 32 for convenience and/or aesthetics.

One or more software programs resident on a server in the cloud (and/or in situ or adjacent cabinet 10a, if desired) may be provided to control the functions of the electromechanical components including the user interface 32. User interface controls may include a “Scan and Stock” function where bottles are picked by robot from the load compartment 30, the bottle label is positioned for scanning for identification and the bottle is placed by the robot in a known location within the rack. The user would thus initiate this functionality at the user interface.

The software may include providing the user with information concerning the selected bottle, e.g., the pedigree of the wine including expert tasting notes and suggested food pairings. This information may be provided in a database and/or via links to third party websites which the software accesses upon identifying the information on the bottle label.

The software may allow the user other functionality such as, for example, the ability to lock certain areas of the rack to only specific users. This would allow the user to ensure only specific users can retrieve what might be a very expensive bottle of wine. The software could thus include security features and parental controls.

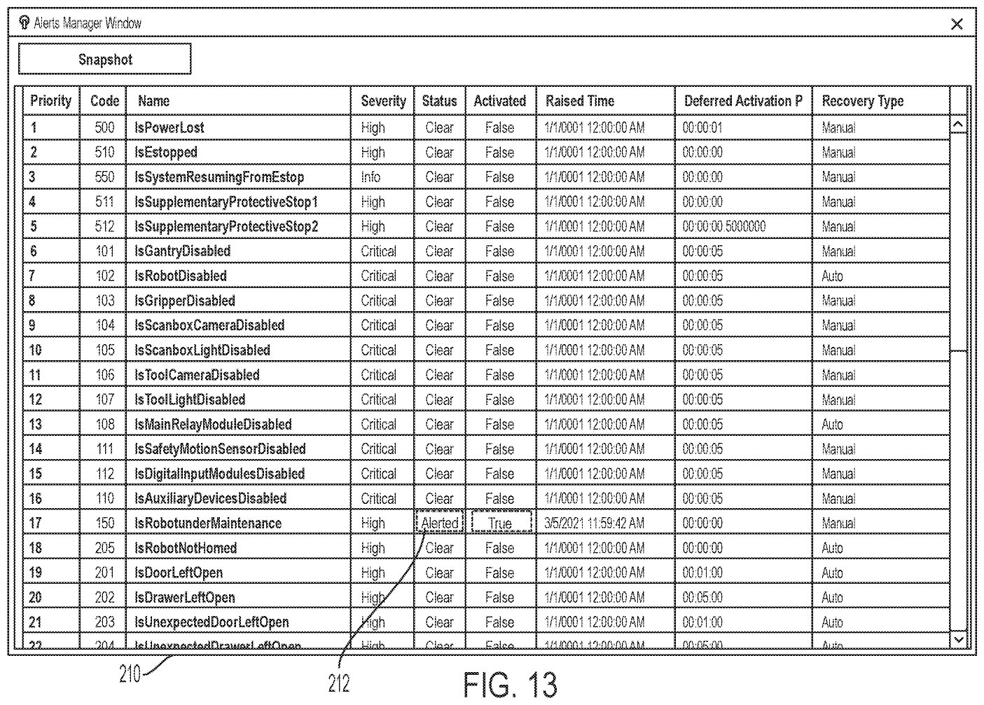

One or more cameras may be provided within or adjacent cabinet 10a. The one or more cameras may have lens covers whereby the user may selectively cover a camera whenever desired (e.g., for privacy concerns). One or more sensors may also be provided within or adjacent cabinet 10a. By way of example, and with reference to FIG. 3, cabinet 10a may include an infrared (IR) motion sensor 42 disposed so as to monitor bottles B within racks 12. Respective positional sensors (not shown) may be located on or near compartment 30 and/or bottle access door 36. These positional sensors may then monitor the condition of the compartment 30/door 36 and initiate a warning or error message should the compartment or door not be properly closed and secured. In a further non-limiting example, gantry 20 and/or robotic arm 14 may also include positional sensors (not shown) to monitor the position and/or orientation of the robotic arm 14 within the cabinet interior. A warning or error message may then be initiated should the gantry or robotic arm fail to return to their “Home” positions following completion of an instructed action, for example (see e.g., FIG. 13, error 212 indicated within the remote maintenance “Alerts Manager” action table 210). It should be further noted that additional or other sensors may be selectively positioned on or within cabinet 10a as desired or dictated by the intended use of the cabinet 10a.

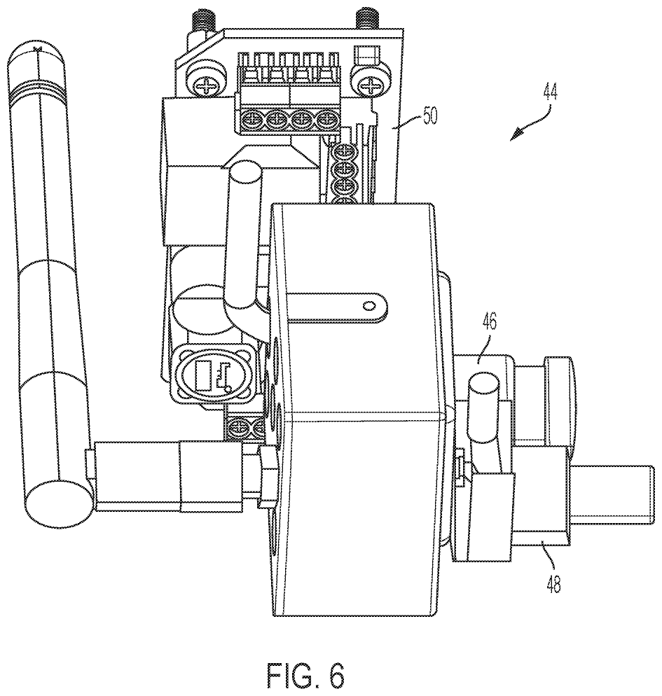

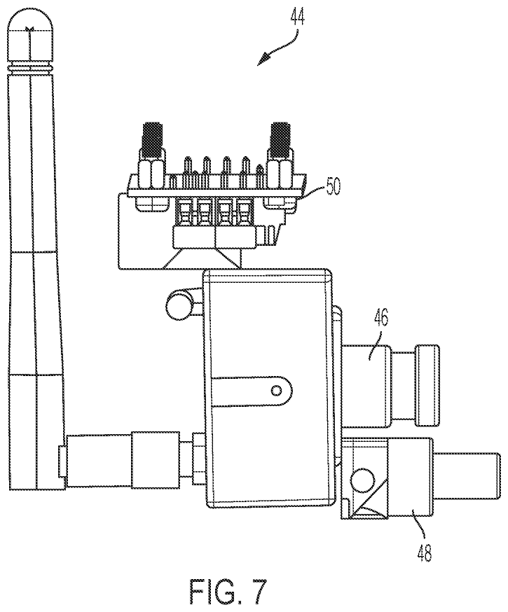

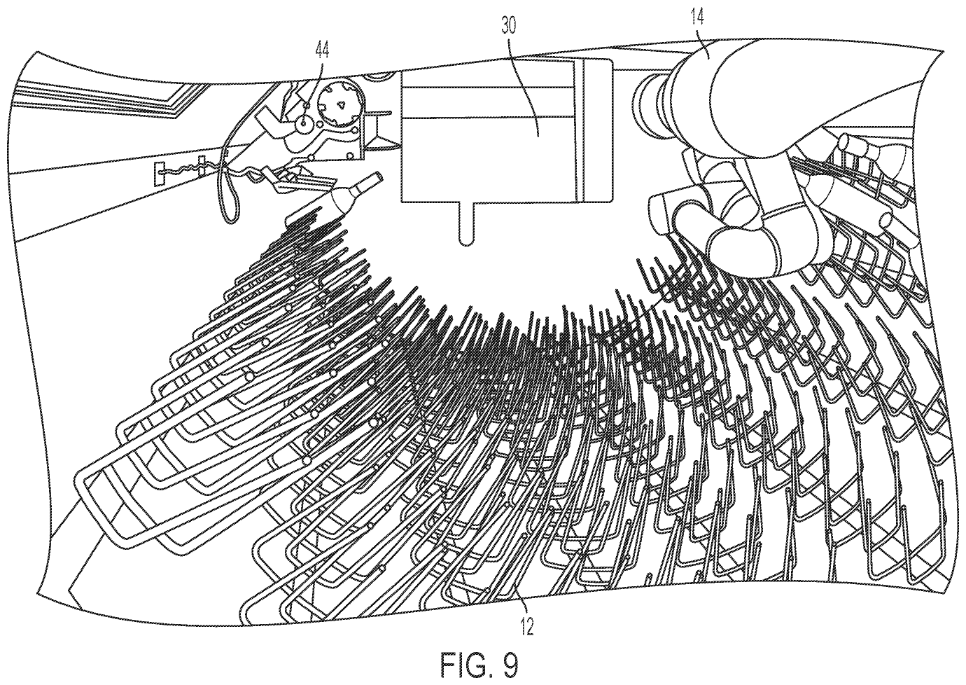

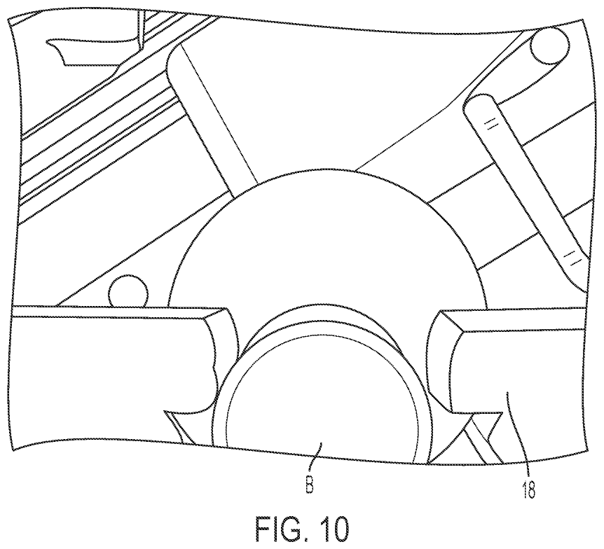

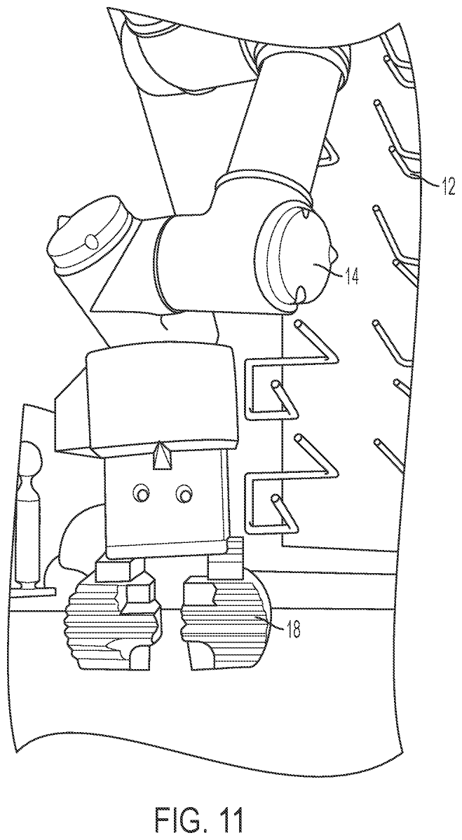

With additional reference to FIGS. 9-11, a first camera may be located adjacent IR motion sensor 42 (FIG. 9), a second camera may be located at the end of tool 18 (FIG. 10) and a third camera 44 (see FIG. 2) may be located adjacent load cell 38 (FIG. 11). As shown most clearly in FIGS. 6 and 7, third camera 44 includes a camera unit 46, lighting unit 48 and camera interface 50. Third camera 44 may be position such that the field of view of camera unit 46 captures an image of any wine bottle B placed within load cell 38. Lighting unit 48 provides additional illumination of the wine bottle label whereby the software includes character recognition algorithms which analyze the wine bottle label to extract identifying information, such as winery name, type of wine and year of vintage. This identifying information, along with the bottle location within racks 12, may then be stored within the system memory. Interface 32 may then present the identifying information, as well as the tasting notes and food pairing recommendations compiled by the software and/or third party websites, when a user is selecting a bottle B from the array. In a further aspect of the present invention, third camera 44 may also assist tool 18 in properly aligning the wine bottle B within rack 12 such that the wine label is optimally presented to a viewer.

With the above description, the following paragraphs more specifically describe various operations conducted by the various components of wine cabinet 10a.

Robot bottle handling

Robot bottle handling may involve one or more of the following in no particular order:

1. Robotic arm/tool 14/18 picking a bottle from the load compartment 30;

2. Robotic arm/tool 14/18 placing the picked bottle in load cell 38 and/or in the viewing area of third camera 44 located within the cabinet;

3. Robotic arm/tool 14/18 moving the picked bottle to a location within the cabinet such as rack 12, a single bottle chiller and/or a single pour area;

4. Robotic arm/tool 14/18 picking a bottle from the rack 12;

5. Robotic arm/tool 14/18 moving the picked bottle to a location in the cabinet, e.g., to allow user to view bottle label and/or to scan label using third camera 44 within the cabinet;

6. Robotic arm/tool moving the picked bottle to retrieval area 40 or back to rack 12.

Remote Assistance Procedure

In the event of a malfunction of the electrical, mechanical and/or electromechanical components within cabinet 10, remote assistance may be provided via internet connection. In one embodiment, one or more of the following procedures may be provided to allow a user to request help from a remote support team and allow the support team the ability to diagnosis and repair the malfunction:

Via the user interface 32:
select “Customer Help Request and Provide Remote Access”;
securely Login to the Winecab™ PC
Remote Maintenance by Support Team initiated
once functionality is restored, a thank you message is displayed and the user selects “Revoke the Remote Access” thereby terminating the internet connection to the remote support team.

Step 1—Customer Help Request and Provide Remote Access
1) The user can contact the support team at the phone number provided which appears under the HELP CENTER or similar screen at the user interface 32:
2) The support contact person will answer the call and ask the customer for his/her contact phone number to let the support team call the customer back if the connection will be lost for any unexpected reasons.
3) The support contact person will ask the customer to click on Remote Assistance Button to navigate to REMOTE ASSISTANCE screen.
4) The support contact person on the phone will read the privacy terms and after getting the customer's confirmation by verbally accepting the privacy terms previously read to him/her, will ask the customer to provide the support team the remote access to the customer's cabinet. To this end, the customer will be asked click on the Grant Access button on the bottom of the REMOTE ASSISTANCE screen.
5) The customer will be asked to stay online if possible while the remote maintenance is being made by the support team; otherwise, if the customer would rather be notified after the maintenance has been made, the support contact person will notify the customer afterwards.

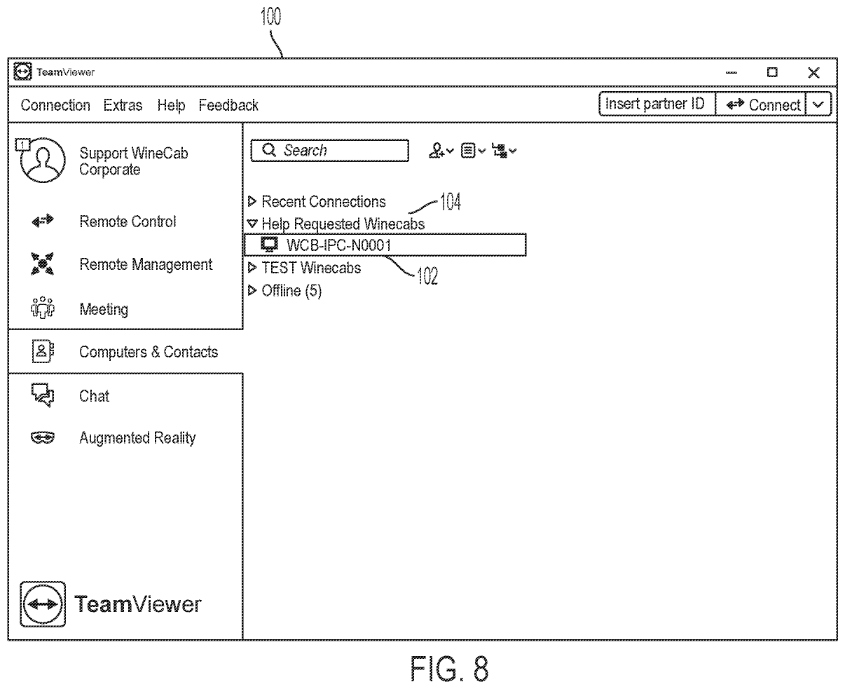

Step 2—Secure Login to the Winecab PC
1) As soon as the customer provides access, the support team will receive a support ticket email at support@xxxx.com.
   At the same time, the icon 102 corresponding to Winecab system with granted access will appear under the Help Requested Winecab folder 104 of Team Viewer Application on the support team PCs. (See screenshot 100 shown in FIG. 8)

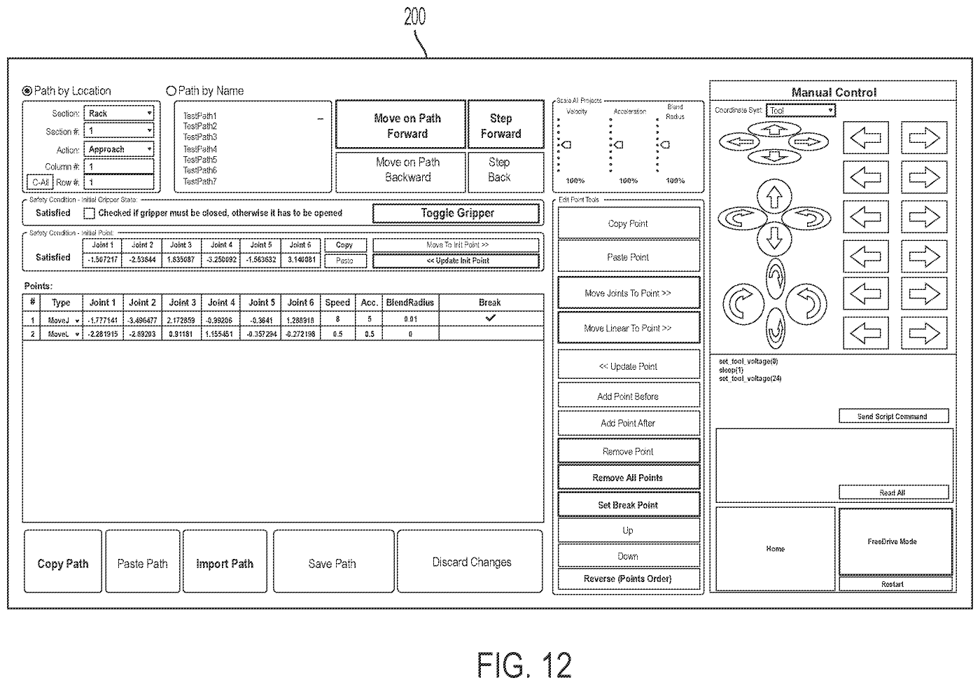

Step 3—Remote Maintenance by Support Team initiated
1) The Winecab support team will login to the help-requested Winecab PC remotely through the secure Team Viewer service.
2) The Winecab support team will take control of the Winecab Logics Control Software to make the changes and fixes which are required to keep the Winecab continue working. In the Logics Control Software, there have been designed many remote management features, among which the two most useful and important ones are:
   A) The support team can look at different cameras' views to check if any physical issues occurred:
   FIG. 9—Top View (Security Camera)
      FIG. 10—End of Arm View (EOA Tool Camera)
      FIG. 11—Side View (Camera in Bottle Label Scanning Box)
   B) The support team can also access to the remote control and maintenance screens (see e.g., robot control screenshot 200 shown in FIG. 12;) such as to reset the gantry/robotic arm, jog the robot, and also teach the new points to database to fix the bottle offset on the rack or in the drawer while looking at the camera views:
3) After the remote maintenance task is accomplished by the Winecab support team, the team will remotely log out from the Winecab PC and let the support contact person know the progress to follow up with the customer.

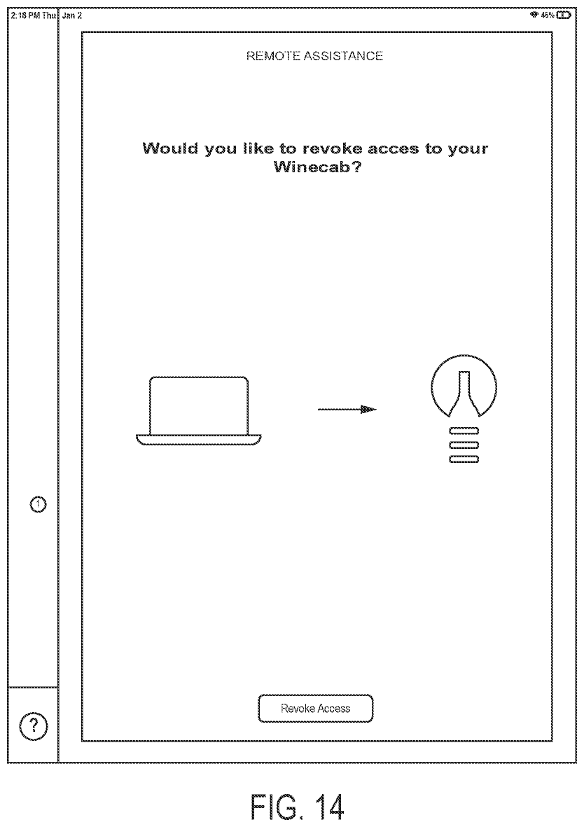

Step 4—Thank You Message and Revoke the Remote Access
1) The support contact person will thank the customer for his/her patience if the customer has been stayed online while the remote maintenance is being made by the support team, otherwise if the customer preferred to be notified after the maintenance had been made, the support contact person call the customer afterwards using the contact number provide in step 1.
2) The support contact person will appreciate customer for his/her help to fix the Winecab problem, and the customer will be asked to click on the Revoke Access button on the bottom of the REMOTE ASSISTANCE screen before ending the conversation. (See FIG. 14)

Although the present invention has been described in considerable detail with reference to certain aspects thereof, other versions are possible. Therefore, the spirit and scope of the appended claims should not be limited to the description of the aspects contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A cabinet for consumer goods comprising;
a) a cabinet housing;
b) a rack system disposed within said cabinet housing, wherein said rack system defines a plurality of discrete locations, wherein each respective location is configured to hold and display a respective consumer good therein;
c) a multi-axis robotic arm adapted to selectively engage said each respective location of said plurality of discrete locations to either insert or extract each respective consumer good;
d) a user control interface in operational communication with said multi-axis robotic arm whereby a user controls said multi-axis robotic arm to selectively insert or extract one or more of the consumer goods from its respective location; and
e) an access door located within said cabinet housing, said access door reciprocally movable between an open position and a closed position whereby said selectively extracted consumer good is retrievable from said cabinet housing when said access door is in said open position.

2. The cabinet of claim 1 further comprising:
a) a controller operably coupled to said multi-axis robotic arm and said user control interface; and
b) a WIFI adapter communicatively coupled to said controller, whereby said WIFI adapter permits internet connectivity between said controller and a remote server.

3. The cabinet of claim 2 wherein said controller communicates with a remote service technician whereby said cabinet is remotely reparable by the technician.

4. The cabinet of claim 1 further including a load cell coupled to said access door, wherein said selectively extracted consumer good is placed within said load cell prior to opening of said access door.

5. The cabinet of claim 4 further comprising a camera having a field of view configured to capture an image of said selectively extracted consumer good when said selectively extracted consumer good is located within said load cell.

6. The cabinet of claim 1 wherein said cabinet housing further comprises a base unit having a compartment defined therein, wherein replacement consumer goods are placed within said compartment whereby said multi-axis robotic arm is operable to pick replacement consumer goods from said compartment and load said rack system with the replacement consumer goods.

7. The cabinet of claim 1 wherein said consumer goods are bottles of wine.

8. The cabinet of claim 7 further comprising a chiller configured to maintain said bottles of wine at a preselected temperature.

9. The cabinet of claim 7 wherein said multi-axis robotic arm includes a tool configured to releasably grasp a neck of a bottle of wine.

10. The cabinet of claim 1 further comprising:
a) a camera communicatively coupled to said user control interface and having a field of view configured to capture an image of each of said respective consumer goods; and
b) a database storing information for each of said respective consumer goods, wherein said user control interface displays said information for said selectively extracted consumer good when captured by said camera.

11. The cabinet of claim 1 further comprising a WIFI adapter communicatively coupled to said user control interface, wherein said database is a third-party database accessible by said user control interface via said WIFI adapter to retrieve and display said information.

12. A method for remote maintenance of a cabinet, the method comprising:
a) providing a cabinet having a cabinet housing; a rack system disposed within said cabinet housing, wherein said rack system defines a plurality of discrete locations, wherein each respective location is configured to hold and display a respective consumer good therein; a multi-axis robotic arm adapted to selectively engage said each respective location of said plurality of discrete locations to either insert or extract each respective consumer good; a user control interface in operational communication with said multi-axis robotic arm whereby a user controls said multi-axis robotic arm to selectively insert or extract one or more of the consumer goods from its respective location; an access door located within said cabinet housing, said access door reciprocally movable between an open position and a closed position whereby said selectively extracted consumer good is retrievable from said cabinet housing when said access door is in said open position; a controller operably coupled to said multi-axis robotic arm and said user control interface; and a WIFI adapter communicatively coupled to said control, whereby said WIFI adapter permits internet connectivity between said controller and a remote server;
b) communicating, via said user control interface through an internet connection, with a remote service technician;
c) providing said remote service technician access to said controller;
d) permitting said remote service technician to perform remote maintenance to said cabinet; and
e) terminating remote access once remote maintenance has been completed.

13. A method for remote maintenance of a cabinet, the method comprising:
a) providing a cabinet having a cabinet housing; a rack system disposed within said cabinet housing, wherein said rack system defines a plurality of discrete locations, wherein each respective location is configured to hold and display a respective consumer good therein; a multi-axis robotic arm adapted to selectively engage said each respective location of said plurality of discrete locations to either insert or extract each respective consumer good; a user control interface in operational communication with said multi-axis robotic arm whereby a user controls said multi-axis robotic arm to selectively insert or extract one or more of the consumer goods from its respective location; an access door located within said cabinet housing, said access door reciprocally movable between an open position and a closed position whereby said selectively extracted consumer good is retrievable from said cabinet housing when said access door is in said open position; a controller operably coupled to said multi-axis robotic arm and said user control interface; and a WIFI adapter communicatively coupled to said control, whereby said WIFI adapter permits internet connectivity between said controller and a remote server;
b) communicating via an internet connection with said controller;
c) gaining access to said controller;
d) performing remote maintenance to said cabinet; and
e) terminating remote access once remote maintenance has been completed.

14. The method of claim 13 wherein said step of performing remote maintenance includes one or both of accessing one or more cameras located on or within said cabinet, and accessing a robot control interface to remotely manipulate said multi-axis robotic arm.
